(19) United States
(12) Patent Application Publication
(10) Pub. No.: US 2010/0190956 A1
(43) Pub. Date: Jul. 29, 2010

(54) POLYANILINE VIOLOGEN CHARGE TRANSFER COMPLEXES CONTAINING INTERMEDIATE TRANSFER MEMBERS

(75) Inventor: Jin Wu, Webster, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: Xerox Corporation, Norwalk, CT (US)

(21) Appl. No.: 12/360,190

(22) Filed: Jan. 27, 2009

(51) Int. Cl. C08G 73/06; G03G 5/00

(52) U.S. Cl. 528/423; 430/75

(57) ABSTRACT

An intermediate transfer media, such as a belt, that includes a polyaniline viologen charge transfer complex.

### CROSS REFERENCE TO RELATED APPLICATIONS

Copending U.S. application Ser. No. (not yet assigned—Attorney Docket No. 20080975-US-NP) on Polypyrrole Containing Intermediate Transfer Components, filed concurrently herewith with the listed individual of Jin Wu, the disclosure of which is totally incorporated herein by reference, illustrates an intermediate transfer member comprised of a substrate comprising a carbon black which is surface treated with a polypyrrole.

Copending U.S. application Ser. No. (not yet assigned—Attorney Docket No. 20080998-US-NP) on Nano Diamond Containing Intermediate Transfer Members, filed concurrently herewith with the listed individual of Jin Wu, the disclosure of which is totally incorporated herein by reference, illustrates an intermediate transfer member comprised of a nano diamond.

Illustrated in U.S. application Ser. No. 12/200,111 (Attorney Docket No. 20080580-US-NP) filed Aug. 28, 2008, entitled Hydrophobic Polyetherimide/Polysiloxane Copolymer Intermediate Transfer Components, the disclosure of which is totally incorporated herein by reference, is an intermediate transfer member comprised of a substrate comprising a polyetherimide polysiloxane copolymer.

Illustrated in U.S. application Ser. No. 12/200,147 (Attorney Docket No. 20080670-US-NP) filed Aug. 28, 2008, entitled Coated Seamed Transfer Member, the disclosure of which is totally incorporated herein by reference, is a process which comprises providing a flexible belt having a welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the seam with a crosslinked acrylic resin.

Illustrated in U.S. application Ser. No. 12/200,074 (Attorney Docket No. 20080579-US-NP) filed Aug. 28, 2008, entitled Hydrophobic Carbon Black Intermediate Transfer Components, the disclosure of which is totally incorporated herein by reference, is an intermediate transfer member comprised of a substrate comprising a carbon black surface treated with a poly(fluoroalkyl acrylate).

Illustrated in U.S. application Ser. No. 12/200,179 (Attorney Docket No. 20080671-US-NP) filed Aug. 28, 2008, entitled Coated Transfer Member, the disclosure of which is totally incorporated herein by reference, is a process which comprises providing a flexible belt having a welded seam extending from one parallel edge to the other parallel edge, the welded seam having a rough seam region comprising an overlap of two opposite edges; contacting the rough seam region with a heat and pressure applying tool; and smoothing out the rough seam region with heat and pressure applied by the heat and pressure applying tool to produce a flexible belt having a smooth welded seam, and subsequently coating the belt with a crosslinked acrylic resin.

Illustrated in U.S. application Ser. No. 12/129,995, filed May 30, 2008, entitled Polyimide Intermediate Transfer Components, the disclosure of which is totally incorporated herein by reference, is an intermediate transfer belt comprised of a substrate comprising a polyimide and a conductive component wherein the polyimide is cured at a temperature of from about 175° C. to about 290° C. over a period of time of from about 10 minutes to about 120 minutes.

Illustrated in U.S. application Ser. No. 12/181,354, filed Jul. 29, 2008, entitled Core Shell Intermediate Transfer Components, the disclosure of which is totally incorporated herein by reference, is an intermediate transfer belt comprised of a substrate comprising a conductive core shell component.

Illustrated in U.S. application Ser. No. 12/181,409, filed Jul. 29, 2008, entitled Treated Carbon Black Intermediate Transfer Components, the disclosure of which is totally incorporated herein by reference, is an intermediate transfer members comprised of a substrate comprising a poly(vinylalkoxysilane) surface treated carbon black.

### BACKGROUND

Disclosed are intermediate transfer members, and more specifically, intermediate transfer members useful in transferring a developed image in an electrostatographic, for example xerographic, including digital, image on image, and the like, machines or apparatuses and printers. In embodiments, there are selected intermediate transfer members comprised of a polyaniline/viologen charge transfer complex (oxidative doping) where viologen refers, for example, to diquaternary derivatives of 4,4′-bipyridyl, and to extended viologens which are conjugated oligomers based, for example, on aryl, alkylene like ethylene, and thiophenes located between the pyridine groups. In embodiments thereof, the polyaniline viologen charge transfer complexes are dispersed in or mixed with a suitable polymer, such as a polycarbonate. Also disclosed herein are processes for the preparation of the polyaniline viologen charge transfer complexes.

A number of advantages are associated with the intermediate transfer members, such as belts (ITB) of the present disclosure, such as an excellent maintained conductivity for extended time periods; dimensional stability; ITB humidity insensitivity for extended time periods; excellent dispersability in a polymeric solution; and low and acceptable surface friction characteristics.

In a typical electrostatographic reproducing apparatus, a light image of an original to be copied is recorded in the form of an electrostatic latent image upon a photosensitive member, and the latent image is subsequently rendered visible by the application of electroscopic thermoplastic resin particles and colorant. Generally, the electrostatic latent image is developed by contacting it with a developer mixture comprised of a dry developer mixture, which usually comprises carrier granules having toner particles adhering triboelectrically thereto, or a liquid developer material, which may include a liquid carrier having toner particles dispersed therein. The developer material is advanced into contact with the electrostatic latent image, and the toner particles are deposited thereon in image configuration. Subsequently, the developed image is transferred to a copy sheet. It is advantageous to transfer the developed image to a coated intermediate transfer web, belt or component, and subsequently transfer with a high transfer efficiency the developed image from the intermediate transfer member to a permanent substrate. The toner image is subsequently usually fixed or fused upon a support, which may be the photosensitive member itself, or other support sheet such as plain paper.

In electrostatographic printing machines wherein the toner image is electrostatically transferred by a potential difference between the imaging member and the intermediate transfer member, the transfer of the toner particles to the intermediate transfer member, and the retention thereof should be substantially complete so that the image ultimately transferred to the image receiving substrate will have a high resolution. Substantially about 100 percent toner transfer occurs when most or all of the toner particles comprising the image are transferred, and little residual toner remains on the surface from which the image was transferred.

Intermediate transfer members possess a number of advantages, such as enabling high throughput at modest process speeds; improving registration of the final color toner image in color systems using synchronous development of one or more component colors, and using one or more transfer stations; and increasing the number of substrates that can be selected. However, a disadvantage of using an intermediate transfer member is that a plurality of transfer operations is usually needed allowing for the possibility of charge exchange occurring between toner particles and the transfer member which ultimately can lead to less than complete toner transfer, resulting in low resolution images on the image receiving substrate, and image deterioration. When the image is in color, the image can additionally suffer from color shifting and color deterioration.

Attempts at controlling the resistivity of intermediate transfer members by, for example, adding conductive fillers, such as ionic additives and/or carbon black, to the outer layer, are disclosed in U.S. Pat. No. 6,397,034, which describes the use of fluorinated carbon filler in a polyimide intermediate transfer member layer. However, there can be problems associated with the use of such fillers in that undissolved particles frequently bloom or migrate to the surface of the fluorinated polymer and cause imperfections in the polymer, thereby causing nonuniform resistivity, which in turn causes poor antistatic properties, and poor mechanical strength characteristics. Also, ionic additives on the ITB surface may interfere with toner release. Furthermore, bubbles may appear in the polymer, some of which can only be seen with the aid of a microscope, and others of which are large enough to be observed with the naked eye resulting in poor or nonuniform electrical properties and poor mechanical properties.

In addition, the ionic additives themselves are sensitive to changes in temperature, humidity, and operating time. These sensitivities often limit the resistivity range. For example, the resistivity usually decreases by up to two orders of magnitude or more as the humidity increases from about 20 percent to 80 percent relative humidity. This effect limits the operational or process latitude.

Moreover, ion transfer can also occur in these systems with ionic additives. The transfer of ions leads to charge exchanges and insufficient transfers, which in turn causes low image resolution and image deterioration, thereby adversely affecting the copy quality. In color systems, additional adverse results include color shifting and color deterioration. Ion transfer also increases the resistivity of the polymer member after repetitive use. This can limit the process and operational latitude, and eventually the ion filled polymer member will be unusable.

A number of the known ITB formulations apply carbon black (CB) or polyaniline as the conductive species; however, this has some limitations. For example, polyaniline is readily oxidized and results in loss of conductivity; its thermal stability is usually limited to about 200° C.; and it begins to lose its conductivity at above 200° C. Also, it can be difficult to prepare carbon black based ITBs with consistent resistivity because the required loadings reside on the vertical part of the percolation curve.

Therefore, it is desired to provide an intermediate transfer member, which has excellent transfer capabilities; is conductive, and more specifically, has improved conductivity as compared, for example, to an intermediate transfer member where a charge transfer complex is absent; possesses excellent humidity insensitivity characteristics leading to high copy quality where developed images with minimal resolution issues can be obtained. It is also desired to provide a weldable intermediate transfer belt that may not, but could, have puzzle cut seams, and instead, has a weldable seam, thereby providing a belt that can be manufactured without labor intensive steps, such as manually piecing together the puzzle cut seam with fingers, and without the lengthy high temperature and high humidity conditioning steps.

### REFERENCES

Illustrated in U.S. Pat. No. 7,031,647 is an imageable seamed belt containing a lignin sulfonic acid doped polyaniline.

Illustrated in U.S. Pat. No. 7,139,519 is an intermediate transfer belt, comprising a belt substrate comprising primarily at least one polyimide polymer; and a welded seam.

Illustrated in U.S. Pat. No. 7,130,569 is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707; 6,318,223, and 6,440,515.

Illustrated in U.S. Pat. No. 6,602,156 is a polyaniline filled polyimide puzzle cut seamed belt, however, the manufacture of a puzzle cut seamed belt is labor intensive and costly, and the puzzle cut seam, in embodiments, is sometimes weak. The manufacturing process for a puzzle cut seamed belt usually involves a lengthy in time high temperature and high humidity conditioning step. For the conditioning step, each individual belt is rough cut, rolled up, and placed in a conditioning chamber that is environmentally controlled at about 45° C. and about 85 percent relative humidity, for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belts electrical properties, which in turn results in poor image quality.

### SUMMARY

In embodiments, there is disclosed an intermediate transfer member comprised of a substrate comprising a polyaniline viologen charge transfer complex; a transfer media comprised of a conductive polyaniline viologen charge transfer complex; an intermediate transfer member, such as an intermediate belt comprised of a substrate comprising a polyaniline viologen charge transfer complex; an intermediate transfer member wherein the resisitivity thereof is from about 10⁶ to about 10¹³ ohm/square, from about 10⁸ to about 10¹² ohm/square, and more specifically, from about 10⁹ to about 10¹¹ ohm/square, which resistivity is about one order of magnitude lower thus higher conductivity than that of an intermediate belt comprised of a substrate comprising a polyaniline.

In embodiments, there is disclosed an intermediate transfer member comprised of a substrate comprising a polyaniline viologen charge transfer complex with an excellent maintained resistivity for extended time periods for the member. More specifically, there is almost no change in the intermediate transfer member surface resistivity with, for example, an intermediate transfer member comprised of a substrate comprising a polyaniline viologen charge transfer complex, and when is aged in J zone (75° F./10 percent humidity) for two months, in comparison and under the same conditions, to an about 500 percent increase in surface resistivity for an intermediate transfer member comprised of a substrate comprising a polyaniline.

In addition, the present disclosure provides, in embodiments, an apparatus for forming images on a recording medium comprising a charge retentive surface to receive an electrostatic latent image thereon; a development component to apply toner to the charge retentive surface to develop the electrostatic latent image, and to form a developed image on the charge retentive surface; a weldable intermediate transfer belt to transfer the developed image from the charge retentive surface to a substrate, and a fixing component.

### DETAILED DESCRIPTION

Aspects of the present disclosure relate to an intermediate transfer member comprised of a substrate and a polyaniline viologen charge transfer complex; a transfer media comprised of a polyaniline viologen complex component; and an apparatus for forming images on a recording medium comprising; a charge retentive surface to receive an electrostatic latent image thereon; a development component to apply toner to the charge retentive surface to develop the electrostatic latent image, and to form a developed image on the charge retentive surface; and an intermediate transfer media that functions to transfer the developed image from the charge retentive surface to a substrate, wherein the intermediate transfer media is comprised of a substrate comprising a polyaniline viologen charge transfer complex.

Examples of the viologens that function primarily as an oxidative dopant for the polyaniline are represented by

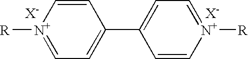

wherein each R is at least one of alkyl and aryl, and more specifically, where each R alkyl contains from about 1 to about 18, or from about 1 to 8 carbon atoms, and aryl contains, for example, from about 6 to about 24, or from about 6 to about 18 carbon atoms; and X⁻ is an anion selected, for example, from the group consisting of a halide such as fluoride, chloride, bromide or iodide, a perchlorate, a carboxylate, and the like.

Specific examples of viologens include benzyl viologen dichloride, methyl viologen dichloride, ethyl viologen dibromide, ethyl viologen diiodide, ethyl viologen diperchlorate, n-octylphenyl viologen dichloride represented by the following structures/formulas

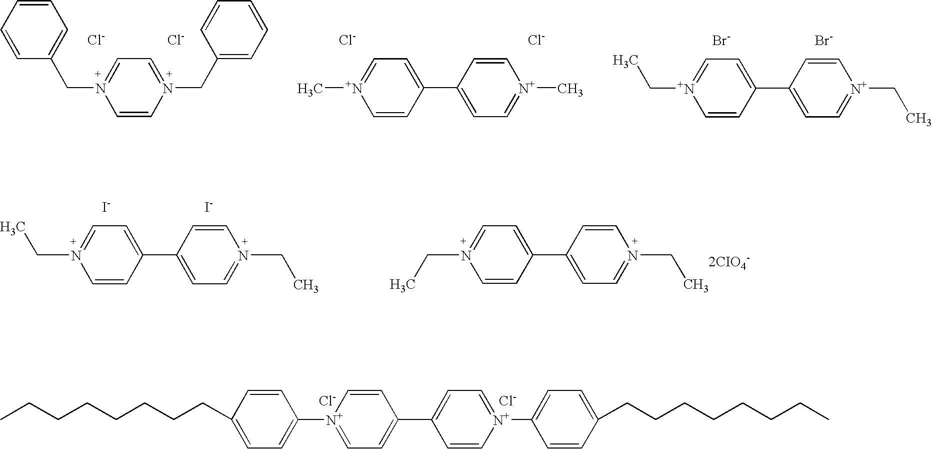

and the like, and mixtures thereof.

Examples of the extended viologens that usually contain phenylene, thiophene, furan, and polyene units between the pyridylium rings, and which viologens function primarily as an oxidative dopant for the polyaniline are represented by the following structure/formula

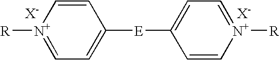

wherein E is, for example, and each n represents the number of repeating groups, such as

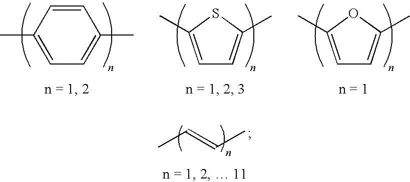

and wherein R is alkyl with, for example, from about 1 to about 18, or from about 1 to 8 carbon atoms, or aryl with, for example, from about 6 to about 24, or from about 6 to about 18 carbon atoms; X⁻ is an anion selected, for example, from the group consisting of a halide such as fluoride, chloride, bromide or iodide, perchlorate, carboxylate, and the like. Generally, n represents the number of segments such as from 1 to about 11, and more specifically, n is 1 or 2; 1, 2, or 3; 1; or 1 to 11.

A specific example of the extended viologen is represented by the following structure/formula

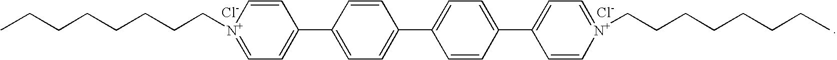

The charge complex can be prepared in accordance with the following scheme and where electrons transfer from the non-conductive emeraldine base to the viologen dications to provide increased conductivity to the already existing conductive emeraldine salt.

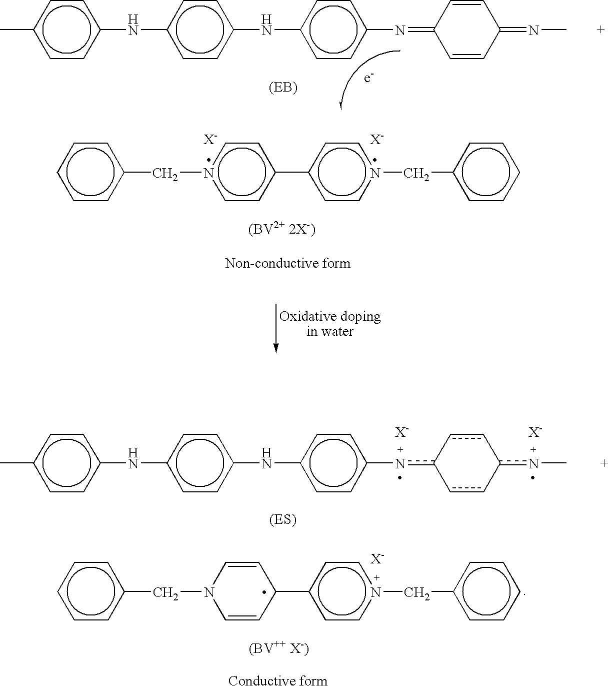

More specifically, when a polyaniline emeraldine base (EB) is mixed with a benzyl viologen dication (BV²+2X⁻) in water, an oxidative doping reaction occurs, and a conductive polyaniline emeraldine salt (ES)/viologen charge transfer complex is formed. With proper known purification procedures, the newly formed complex is isolated from the mixture, and used as a conductive polyaniline for intermediate transfer members with the resistivity of the ITB comprised of the conductive polyaniline/viologen complex being about one order of magnitude lower than that comprised of the polyaniline itself.

Examples of the polyaniline component are, for example, comprised of relatively small particles with, for example, a size diameter of, for example, from about 0.5 to about 5, from about 1.1 to about 2.3, from about 1.2 to about 2, from about 1.5 to about 1.9, or about 1.7 microns. Specific examples of polyanilines selected for the transfer member, such as an ITB, are PANIPOL™ F, commercially available from Panipol Oy, Finland.

The weight ratio of the polyaniline and the viologen in the polyaniline/viologen complex is, for example, from about 30/70 to about 99/1, or from about 60/40 to about 90/10; and the complex is present in an amount of, for example, from about 3 to about 30, or from about 5 to about 20 weight percent of the intermediate transfer member components.

Examples of additional components present in the intermediate transfer member are a number of known polymers, binders, and conductive components.

Examples of the polymeric binders in amounts of, for example, from about 70 to about 97 weight percent, or from about 80 to about 95 weight percent of the intermediate transfer member components selected to disperse the charge transfer complex are polyimides (thermosetting or thermoplastic), polycarbonate, poly(ethylene terephthalate) (PET), poly(ethylene naphthalate) (PEN), poly(butylene terephthalate) (PBT), polyvinylidene fluoride (PVDF), polyethylene-co-polytetrafluoroethylene, and rapidly cured polyimide polymers such as VTEC™ PI 1388, 080-051, 851, 302, 203, 201 and PETI-5, all available from Richard Blaine International, Incorporated, Reading, Pa. The thermosetting polyimides may be cured at suitable temperatures, and more specifically, from about 180° C. to about 260° C. over a short period of time, such as, for example, from about 10 to about 120 minutes, and from about 20 to about 60 minutes, and possess, for example, a number average molecular weight of from about 5,000 to about 500,000, or from about 10,000 to about 100,000, and a weight average molecular weight of from about 50,000 to about 5,000,000, or from about 100,000 to about 1,000,000. Also, there can be selected as polymers thermosetting polyimide precursors that are cured at higher temperatures (above 300° C.) than the VTEC™ PI polyimide precursors, and which precursors include, for example, PYRE-M.L® RC-5019. RC-5057, RC-5069, RC-5097, RC-5053 and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, commercially available from E.I. DuPont, Wilmington, Del.

Examples of specific selected thermoplastic polyimides are KAPTON® KJ, commercially available from E.I. DuPont, Wilmington, Del., as represented by

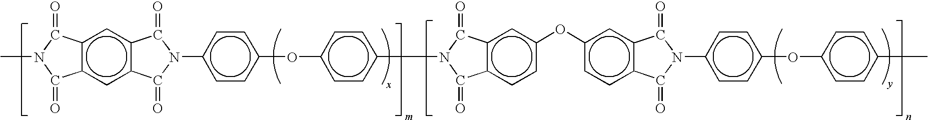

wherein x is equal to 2; y is equal to 2; m and n are from about 10 to about 300; and IMIDEX®, commercially available from West Lake Plastic Company, as represented by

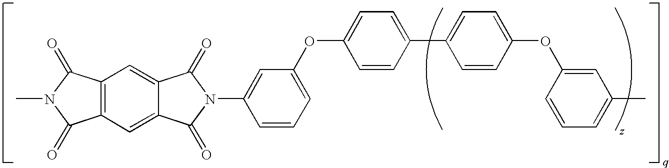

wherein z is equal to 1, and q is from about 10 to about 300.

Examples of polycarbonate binders selected include poly(4,4′-isopropylidene-diphenylene)carbonate (also referred to as bisphenol-A-polycarbonate), poly(4,4′-cyclohexylidine diphenylene)carbonate (also referred to as bisphenol-Z-polycarbonate), poly(4,4′-isopropylidene-3,3′-dimethyl-diphenyl)carbonate (also referred to as bisphenol-C-polycarbonate), and the like. In embodiments, the intermediate transfer member binders are comprised of bisphenol-A-polycarbonate resins, commercially available as MAKROLON®, with a weight average molecular weight of from about 50,000 to about 500,000.

Examples of additional components present in the intermediate transfer member are a number of known conductive components present in an amount of from about 3 to about 20 weight percent such as a second polyaniline or carbon black. In embodiments, the second polyaniline component has a relatively small particle size of, for example, from about 0.5 to about 5, from about 1.1 to about 2.3, from about 1.2 to about 2, from about 1.5 to about 1.9, or about 1.7 microns.

Specific examples of polyanilines selected for the transfer member, such as an ITB, are PANIPOL™ F, commercially available from Panipol Oy, Finland; and lignosulfonic acid grafted polyaniline.

Examples of carbon black include VULCAN® carbon blacks, REGAL® carbon blacks, and BLACK PEARLS® carbon blacks available from Cabot Corporation. Specific examples of conductive carbon blacks are BLACK PEARLS® 1000 (B.E.T. surface area=343 m²/g, DBP absorption=105 ml/g), BLACK PEARLS® 880 (B.E.T. surface area=240 m²/g, DBP absorption=106 ml/g), BLACK PEARLS® 800 (B.E.T. surface area=230 m²/g, DBP absorption=68 ml/g), BLACK PEARLS® L (B.E.T. surface area=138 m²/g, DBP absorption=61 ml/g),. BLACK PEARLS® 570 (B.E.T. surface area=110 m²/g, DBP absorption=114 ml/g), BLACK PEARLS® 170 (B.E.T. surface area=35 m²/g, DBP absorption=122 ml/g), VULCAN® XC72 (B.E.T. surface area=254 m²/g, DBP absorption=176 ml/g), VULCAN® XC72R (fluffy form of VULCAN® XC72), VULCAN® XC605, VULCAN® XC305, REGAL® 660 (B.E.T. surface area=112 m²/g, DBP absorption=59 ml/g), REGAL® 400 (B.E.T. surface area=96 m²/g, DBP absorption=69 ml/g), and REGAL® 330 (B.E.T. surface area=94 m²/g, DBP absorption=71 ml/g).

In embodiments, the polyaniline/viologen charge transfer complex can be dispersed in a rapid curing thermosetting polyimide/N-methyl-2-pyrrolidone (NMP) solution, and then the dispersion can be applied to or coated on a glass plate using known draw bar coating methods. The resulting film or films on the glass plates can be dried at high temperatures, such as from about 100° C. to about 400° C., from about 150° C. to about 300° C., or from about 175° C. to about 200° C. for a sufficient period of time, such as for example, from about 20 to about 180 minutes, or from about 75 to about 100 minutes while remaining on the glass plate. After drying and cooling to room temperature, the film or films on the glass plate or separate glass plates are immersed into water overnight, about 18 to 23 hours, and subsequently, the 50 to 150 microns thick film or films formed are released from the glass resulting in the functional intermediate transfer member or members as disclosed herein.

In embodiments, the polyaniline/viologen charge transfer complex can be dispersed in a bisphenol-A-polycarbonate/methylene chloride (CH₂Cl₂) solution, and then the dispersion can be applied to or coated on a biaxially oriented poly(ethylene naphthalate) (PEN) substrate (KALEDEX™ 2000) having a thickness of about 3.5 mils using known draw bar coating methods. The resulting film or films can be dried at high temperatures, such as from about 100° C. to about 200° C., or from about 120° C. to about 160° C. for a sufficient period of time, such as for example, from about 1 to about 30 minutes, or from about 5 to about 15 minutes while remaining on the PEN substrate. After drying and cooling to room temperature, about 23° C. to about 25° C., the film or films on the PEN substrate or separate PEN substrates are automatically released from the substrate resulting in the functional intermediate transfer member or members as disclosed herein.

The disclosed intermediate transfer members are, in embodiments, weldable, that is the seam of the member like a belt is weldable, and more specifically, may be ultrasonically welded to produce a seam. The surface resistivity of the disclosed intermediate transfer member is, for example, from about 10⁹ to about 10¹³, or from about 10¹⁰ to about 10¹² ohm/square. The sheet resistivity of the intermediate transfer weldable member is, for example, from about 10⁹ to about 10¹³, or from about 10¹⁰ to about 10¹² ohm/square.

The intermediate transfer members illustrated herein, like intermediate transfer belts, can be selected for a number of printing, and copying systems, inclusive of xerographic printing. For example, the disclosed intermediate transfer members can be incorporated into a multi-imaging system where each image being transferred is formed on the imaging or photoconductive drum at an image forming station, wherein each of these images is then developed at a developing station, and transferred to the intermediate transfer member. The images may be formed on the photoconductor and developed sequentially, and then transferred to the intermediate transfer member. In an alternative method, each image may be formed on the photoconductor or photoreceptor drum, developed, and transferred in registration to the intermediate transfer member. In an embodiment, the multi-image system is a color copying system, wherein each color of an image being copied is formed on the photoreceptor drum, developed, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

The intermediate transfer member present in the imaging systems illustrated herein, and other known imaging and printing systems, may be in the configuration of a sheet, a web, a belt, including an endless belt, an endless seamed flexible belt, and an endless seamed flexible belt; a roller, a film, a foil, a strip, a coil, a cylinder, a drum, an endless strip, and a circular disc. The intermediate transfer member can be comprised of a single layer or it can be comprised of several layers, such as from about 2 to about 5 layers. The circumference of the intermediate transfer member, especially as it is applicable to a film or a belt configuration, is, for example, from about 250 to about 2,500 millimeters, from about 1,500 to about 2,500 millimeters, or from about 2,000 to about 2,200 millimeters with a corresponding width of, for example, from about 100 to about 1,000 millimeters, from about 200 to about 500 millimeters, or from about 300 to about 400 millimeters.

Specific embodiments will now be described in detail. These examples are intended to be illustrative, and the disclosure is not limited to the materials, conditions, or process parameters set forth in these embodiments. All parts are percentages by weight of total solids unless otherwise indicated.

### EXAMPLE I

### Preparation of the Polyaniline/Viologen Charge Transfer Complex:

Five grams of PANIPOL® F, an emeraldine salt, obtained from Panipol Oy (Porvoo, Finland), were mixed with 0.5 gram of methyl viologen dichloride hydrate, obtained from Aldrich Chemicals, and 30 grams of distilled water, and where the viologen compound was soluble in water; followed by milling with 300 grams of 2 millimeter stainless shots overnight, about 23 hours, where resulting dispersion was separated from the milling media, and then filtered through a 20 μm Nylon cloth. The resulting dispersion was then centrifuged, and the solid collected was reslurried in water twice; and then centrifuged again to remove any free viologen compound. The final wet cake was dried under vacuum at 80° C. overnight.

The polyaniline/viologen complex product was analyzed using FTIR. A distinct resonance peak at 1,638 cm⁻¹ was present for the polyaniline/viologen complex, which is the characteristic peak of methyl viologen. The polyaniline itself has no such peak present.

### COMPARATIVE EXAMPLE 1

### Preparation of Intermediate Transfer Member Comprised of the Polyaniline:

One gram of PANIPOL® F, an emeraldine salt, obtained from Panipol Oy (Porvoo, Finland), was mixed with 9 grams of a bisphenol-A-polycarbonate, MAKROLON® 5705, and 100 grams of methylene chloride. By ball milling this mixture with 2 millimeter stainless shot overnight, or 23 hours, a uniform dispersion was obtained.

The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 20 micron thick intermediate transfer member of polyaniline/polycarbonate with a ratio by weight of 10/90.

### COMPARATIVE EXAMPLE 2

### Preparation of Intermediate Transfer Member Comprised of the Polyaniline/Viologen Physical Mixture:

One gram of PANIPOL® F, an emeraldine salt, obtained from Panipol Oy (Porvoo, Finland), was mixed with 0.1 gram of methyl viologen dichloride hydrate (Aldrich), 9 grams of a bisphenol-A-polycarbonate, MAKROLON® 5705, and 100 grams of methylene chloride. By ball milling this mixture with 2 millimeter stainless shot overnight, or 23 hours, a uniform dispersion was obtained.

The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate, resulting in a 20 micron thick intermediate transfer member of polyaniline/viologen/polycarbonate with a weight ratio of 9.9/1/89.1, and where the polyaniline and viologen were physically mixed, and there was no or very minimal formation of the polyaniline/viologen charge transfer complex since the viologen salt was almost insoluble in methylene chloride.

### EXAMPLE II

### Preparation of Intermediate Transfer Member Comprised of the Polyaniline/Viologen Charge Transfer Complex:

One gram of the polyaniline/viologen complex of Example I was mixed with 9 grams of a bisphenol-A-polycarbonate, MAKROLON® 5705, and 100 grams of methylene chloride. By ball milling this mixture with 2 millimeter stainless shot overnight, or 23 hours, a uniform dispersion was obtained.

The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate, resulting in a 20 micron thick intermediate transfer member of polyaniline/viologen complex/polycarbonate with a weight percent ratio of 10/90 (complex/polycarbonate).

### Surface Resistivity Measurement

The above ITB members or devices of Comparative Examples 1 and 2, and Example II were measured one day after their preparation for surface resistivity (averaging four to six measurements at varying spots, 72° F./65 percent room humidity) using a High Resistivity Meter (Hiresta-Up MCP-HT450 from Mitsubishi Chemical Corp.). Then the ITB devices were acclimated in J zone (75° F./10 percent humidity) for an aging study, and the surface resistivity was measured again at 1 month and 2 months. The results are provided in Table 1.

TABLE 1

| | | | Surface |
|---|---|---|---|
| | Surface | Surface | Resistivity |
| | Resistivity After 1 | Resistivity After 1 | After 2 Months |
| | Day (ohm/sq) | Month (ohm/sq) | (ohm/sq) |
| Comparative | (1.36 ± 0.21) × 10¹¹ | (3.02 ± 0.31) × 10¹¹ | (8.12 ± 0.40) × |
| Example 1 | | | 10¹¹ |
| Comparative | (2.02 ± 0.34) × 10¹¹ | (3.95 ± 0.24) × 10¹¹ | (7.86 ± 0.13) × |
| Example 2 | | | 10¹¹ |
| Example II | (1.27 ± 0.19) × 10¹⁰ | (1.34 ± 0.21) × 10¹⁰ | (1.31 ± 0.12) × |
| | | | 10¹⁰ |

The disclosed 1 day ITB device of Example II comprised of the disclosed polyaniline/viologen charge transfer complex dispersed in the polycarbonate exhibited one order of magnitude lower surface resistivity thus a higher conductivity than that of the controlled polyaniline dispersed in polycarbonate (Comparative Example 1), and the polyaniline/viologen physical mixture dispersed in polycarbonate (Comparative Example 2). The disclosed polyaniline/viologen charge transfer complex, where it is believed that the electrons transferred from the nonconductive emeraldine base to the viologen dications, provided added conductivity form to the already existing conductive emeraldine salt, thus improved the conductivity of polyaniline.

After 2 months aging in J zone, a stressful environment for ITB aging, the surface resistivity of the disclosed ITB device (Example II with 2 month aging in J zone) remained unchanged, while both the polyaniline ITB device of Comparative Example 1 with 2 month aging in J zone, and the polyaniline/viologen physical mixture ITB device of Comparative Example 2 with 2 month aging in J zone increased.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An intermediate transfer member comprised of a substrate and a polyaniline viologen charge transfer complex.

2. An intermediate transfer member in accordance with claim 1 wherein said polyaniline has a particle size of from about 0.5 to about 5 microns.

3. An intermediate transfer member in accordance with claim 1 wherein said viologen is represented by 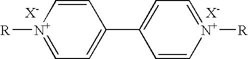
wherein each R is at least one of alkyl and aryl, and X⁻ is an anion.

4. An intermediate transfer member in accordance with claim 3 wherein each R is an alkyl with from about 1 to 8 carbon atoms, or aryl with from about 6 to about 18 carbon atoms; and X⁻ is fluoride, chloride, bromide, or iodide.

5. An intermediate transfer member in accordance with claim 1 wherein said viologen is selected from the group consisting of at least one of

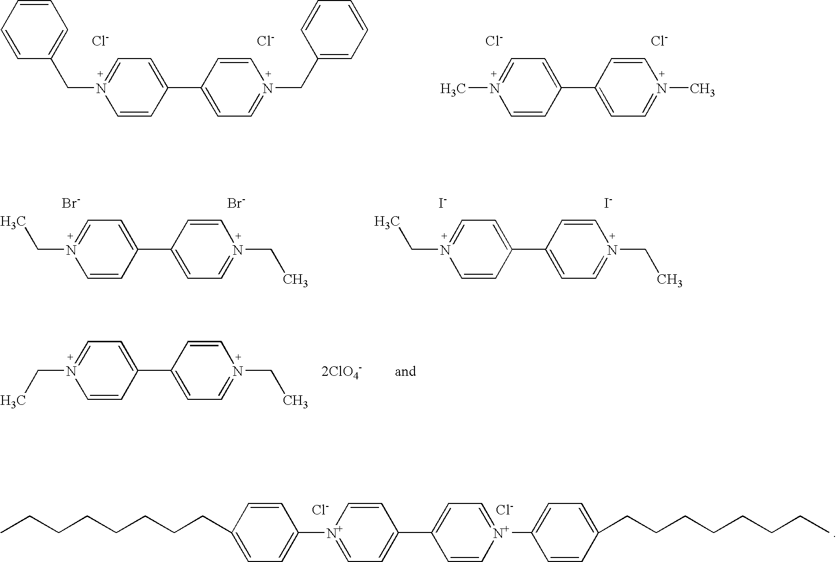

6. An intermediate transfer member in accordance with claim 1 wherein said viologen is an extended viologen represented by 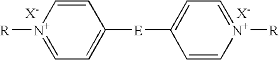
wherein E is represented by 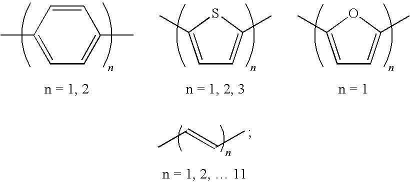
R is alkyl with from about 1 to about 18 carbon atoms, or aryl with from about 6 to about 24 carbon atoms; and X⁻ is an anion selected from a group consisting of a halide, a perchlorate, and a carboxylate.

7. An intermediate transfer member in accordance with claim 1 wherein said viologen is represented by 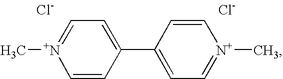
and said polyaniline is an emeraldine salt.

8. An intermediate transfer member in accordance with claim 1 wherein the ratio of said polyaniline to said viologen in said charge transfer complex is from about 30/70 to about 99/1.

9. An intermediate transfer member in accordance with claim 1 wherein the ratio of said polyaniline to said viologen in said charge transfer complex is from about 60/40 to about 90/1 0.

10. An intermediate transfer member in accordance with claim 1 wherein said polyaniline viologen charge transfer complex is present in an amount of from about 1 to about 30 percent by weight based on the weight of total solids.

11. An intermediate transfer member in accordance with claim 1 wherein said polyaniline viologen charge transfer complex is present in an amount of from about 3 to about 12 percent by weight based on the weight of total solids.

12. An intermediate transfer member in accordance with claim 1 wherein said member is a weldable belt.

13. An intermediate transfer member in accordance with claim 1 further including a second polyaniline present in an amount of from about 1 to about 30 percent by weight based on the weight of total solids.

14. An intermediate transfer member in accordance with claim 1 wherein said complex is mixed with a polymer.

15. An intermediate transfer member in accordance with claim 1 wherein said complex is dispersed in a polymer of at least one of a polyimide, a polycarbonate, a poly(butylene terephthalate), a poly(ethylene terephthalate), a poly(ethylene naphthalate), a polyvinylidene fluoride, and a polyethylene-co-polytetrafluoroethylene.

16. An intermediate transfer member in accordance with claim 1 wherein said complex is dispersed in a polycarbonate.

17. An intermediate transfer member in accordance with claim 15 wherein the ratio of said complex to said polymer of at least one of a polyimide, a polycarbonate, a poly(butylene terephthalate), a poly(ethylene terephthalate), a poly(ethylene naphthalate), a polyvinylidene fluoride, and a polyethylene-co-polytetrafluoroethylene is from about 3/97 to about 20/80.

18. An intermediate transfer member in accordance with claim 1 wherein said member has a surface resistivity of from about 10⁶ to about 16¹³ ohm/square.

19. An intermediate transfer member in accordance with claim 18 wherein said surface resistivity is from about 10⁹ to about 10¹² ohm/square.

20. An intermediate transfer member in accordance with claim 1 further comprising an outer release layer positioned on said substrate.

21. An intermediate transfer member in accordance with claim 20 wherein said release layer comprises a poly(vinyl chloride).

22. An intermediate transfer member in accordance with claim 1 wherein said intermediate transfer member has a circumference of from about 250 to about 2,500 millimeters.

23. A transfer media comprised of a polyaniline viologen complex component.

24. A transfer media in accordance with claim 23 wherein said polyaniline viologen charge transfer complex is a polyaniline/benzyl viologen dichloride complex, a polyaniline/methyl viologen dichloride complex, a polyaniline/ethyl viologen dibromide complex, a polyaniline/ethyl viologen diiodide complex, a polyaniline/ethyl viologen diperchlorate complex, or a polyaniline/n-octylphenyl viologen dichloride complex.

25. A transfer media in accordance with claim 24 wherein said transfer media is in the form of a belt, and wherein said polyaniline viologen charge transfer complex is present in an amount of from about 3 to about 18 weight percent, and which complex is mixed with a polymer binder of a polyimide, a polycarbonate, a poly(butylene terephthalate), a poly(ethylene terephthalate), a poly(ethylene naphthalate), a polyvinylidene fluoride, or a polyethylene-co-polytetrafluoroethylene.

26. An apparatus for forming images on a recording medium comprising
a charge retentive surface to receive an electrostatic latent image thereon;
a development component to apply toner to said charge retentive surface to develop said electrostatic latent image, and to form a developed image on said charge retentive surface; and
an intermediate transfer media that functions to transfer the developed image from said charge retentive surface to a substrate, wherein said intermediate transfer media is comprised of a substrate comprising a polyaniline viologen charge transfer complex.

27. An apparatus in accordance with claim 26 wherein the charge retentive surface is a photoconductor.

28. An intermediate transfer member in accordance with claim 1 wherein said member is in the form of a flexible belt, and wherein said polyaniline viologen charge transfer complex is present in an amount of from about 3 to about 20 weight percent, and which complex is dispersed in a polyimide, a polycarbonate, a poly(butylene terephthalate), a poly(ethylene terephthalate), a poly(ethylene naphthalate), a polyvinylidene fluoride, or a polyethylene-co-polytetrafluoroethylene.

29. An intermediate transfer member in accordance with claim 3 wherein each R is alkyl containing from about 1 to about 18 carbon atoms, or aryl containing from about 6 to about 24 carbon atoms; and X⁻ is an anion selected from the group consisting of a halide, perchlorate, and carboxylate.

30. An intermediate transfer member in accordance with claim 3 wherein each R is alkyl containing from about 1 to about 8 carbon atoms, or aryl containing from about 6 to about 18 carbon atoms; and X⁻ is a chloride anion.

31. A transfer media in accordance with claim 23 wherein said viologen is at least one of 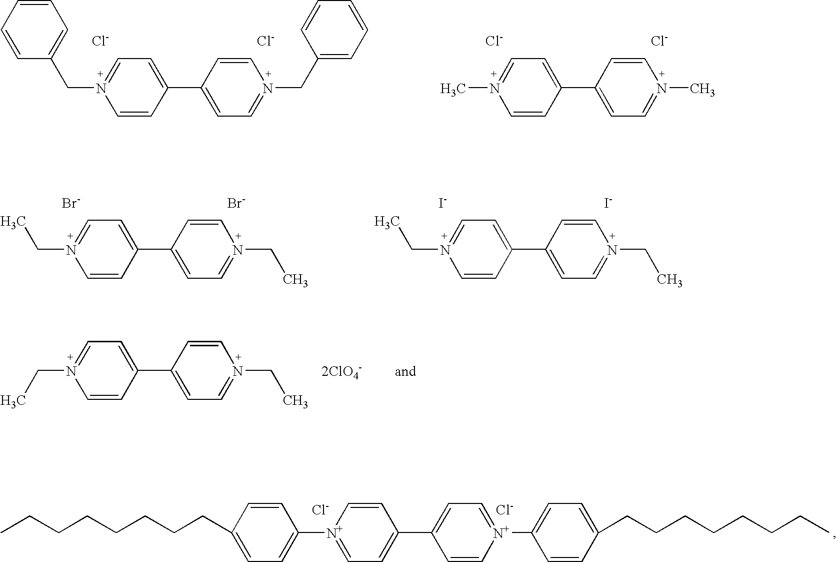
and said polyaniline is an emeraldine salt.
